(19) United States
(12) Patent Application Publication
(10) Pub. No.: US 2016/0133116 A1
(43) Pub. Date: May 12, 2016

(54) INSPECTION AND REGISTRATION TAG EARLY ALERT SYSTEM (IREAS)

(71) Applicant: Adam Awad, Converse, TX (US)

(72) Inventor: Adam Awad, Converse, TX (US)

(21) Appl. No.: 14/535,302

(22) Filed: Nov. 6, 2014

(51) Int. Cl. G08B 21/24; B60Q 9/00

(52) U.S. Cl. CPC G08B 21/24; B60Q 9/00

(57) ABSTRACT

A system comprising a housing, wherein the housing comprising of a front end, a rear end, an opening between the front end and the rear end, a battery receiving member, notification members, a communication member, and a control system; the front end having an attachment member and a solar screen; the rear end having a configuration member, a communication configuration member, a digital display, wherein the first configuration member controlling the communication member, and the configuration member controlling the digital display and the notification members; wherein the attachment member coupling to the inside portion of a windshield of a vehicle; and wherein the opening placing upon a tag.

### BACKGROUND

The present invention relates a notification system, and more specifically, to a notification system for selectively notifying a user that the motor vehicle registration renewal is upcoming and that the yearly motor vehicle inspection is upcoming.

Most states in the United States require vehicles to have current registration and inspection. Some states require vehicles to have tags issued by states evidencing such compliance on the front windshield. These tags face the outside for law enforcement officer to monitor vehicles compliance with the regulations. This is troublesome for drivers because they see the back of those tags, causing them to either confuse the date or miss the upcoming renewal dates.

Therefore, a need exists for a system to generate notifications that the motor vehicle registration and vehicle inspection is upcoming.

### BRIEF DESCRIPTION OF THE DRAWINGS

FIG. 1 shows a notification system for a tag in operation;

FIG. 2 shows a rear view of the notification system for a tag in relation to a tag;

FIG. 3 shows a rear view of the notification system for a tag;

FIG. 4 shows a front view of the notification system for a tag when coupled to the windshield; and

FIG. 5 shows a logical diagram of components of the notification system for a tag.

### DESCRIPTION OF THE INVENTION

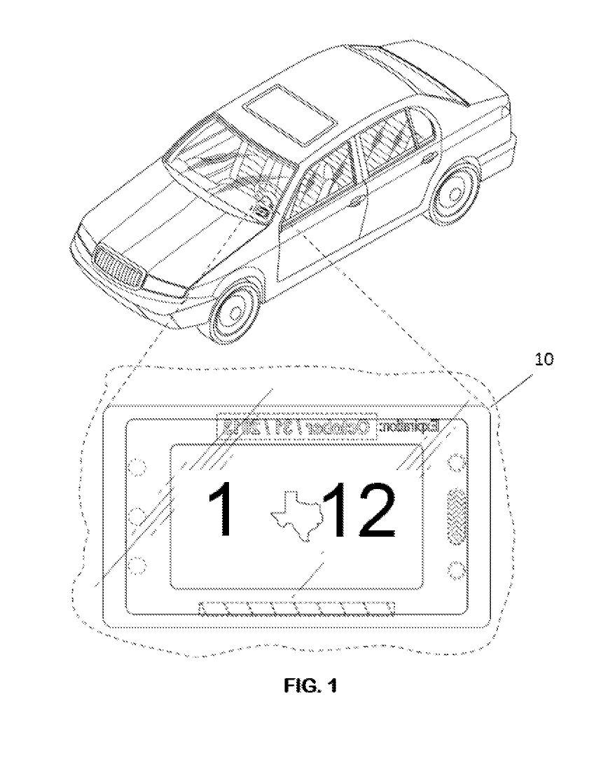

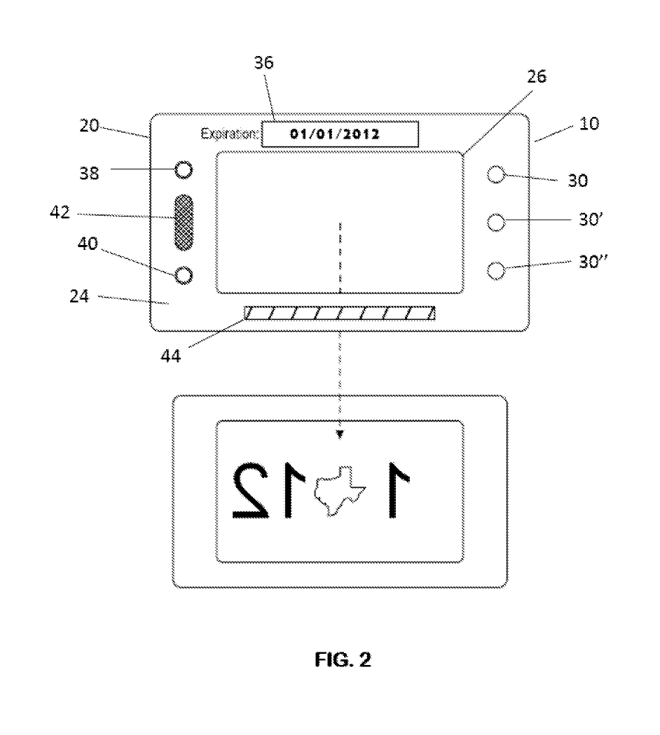

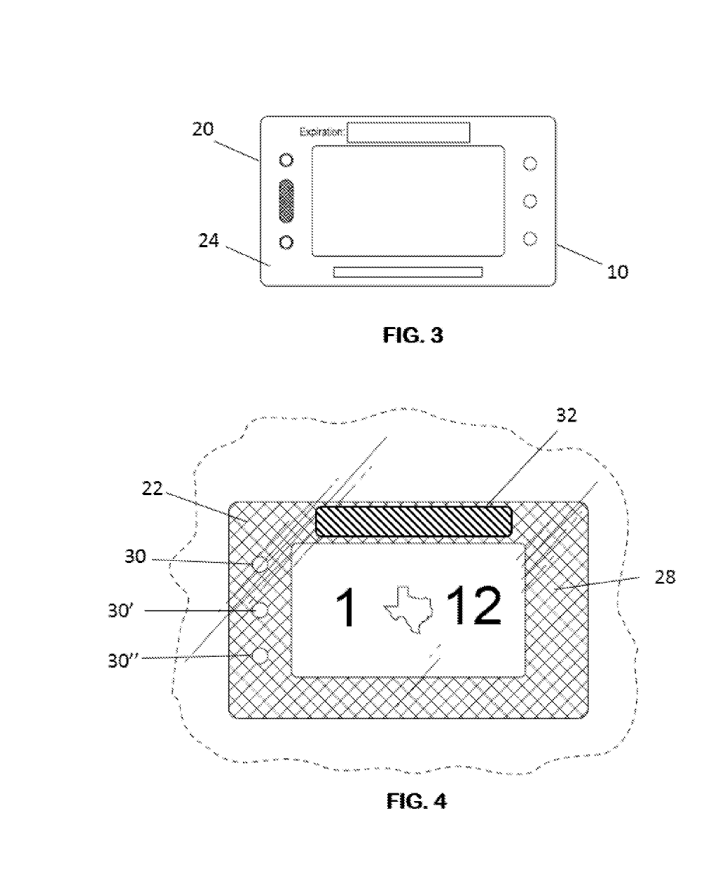

Referring now to FIGS. 1-5, an inspection and/or registration tag (“tag”) early alert system (“IREAS”) 10 is shown. The IREAS 10 generates notification for a tag at least before and upon expiration. The IREAS 10 comprises a housing 20. The housing 20 may be made of plastic, metal, wood, fiberglass, or a combination thereof.

The housing 20 has a rear end 22 and a front end 24. The rear end 22 couples to the front end 24 to form the housing 20. Both rear and front ends 22, 24 have interlocking ledges (not shown) to interlock with each other. Further, the housing 20 includes an opening 26. The opening 26 has a rectangular shape corresponding to a tag. Shape of the opening can be re-designed corresponding to the type of tag used. The opening may be designed large enough to include both inspection and registration tags.

The rear end 22 includes at least one attachment member 28. The attachment member 28 couples to a portion of a windshield. The attachment member 28 may be selected from group consisting of adhesive, Velcro (i.e., hook and loop fastener), suction cup, or a combination thereof. In present embodiment, the attachment member 28 comprises of an adhesive layer coupled to the rear end 22. In some embodiment, the rear end 22 may include at least one Velcro strip attached thereto for coupling to a corresponding Velcro strip attached to the windshield.

In the present embodiment, both rear end 22 and front end 24 include notification members 30, 30′, 30″. The notification members 30, 30′, 30″ include a plurality of colored lights. In some embodiments however, only one of the rear or front ends 22, 24 may include the notification members 30, 30′, 30″. Furthermore, the plurality of the colored lights may be red, yellow, and green lights. The colored lights activate corresponding to the expiration date of the tag. For example, the green light indicates current registration, a yellow light means that the registration is about to expire, and a red light means that the registration has already expired and it is time to renew. In some embodiments, a single light that changes color may be used instead of the plurality of colored lights, where the light color changes corresponding to the expiration date of a tag. The law enforcement personnel may benefit from the IREAS 10 because placing the notification members 30, 30′, 30″ on the front end of the housing 20 allows the law enforcement personnel to identify vehicles with expired registration or inspection tags.

The rear end 24 includes a solar panel 32. The solar panel 32 generates electricity for use by the components of the housing 20. Further, the housing 20 has a battery-receiving member positioned within the housing (not shown) to receive a battery therein. In some embodiments of the present invention, the housing 20 may include either a solar panel 32 or the battery-receiving member. In addition, the rear end 24 includes a battery range display 44 to show the level of the battery reserve. Furthermore, when the IREAS 10 is coupled to a windshield, the solar panel 32 faces the outside of the vehicle. This arrangement allows for maximum exposure light exposure for the solar panel 32, which in turn result in greater electricity production for the housing.

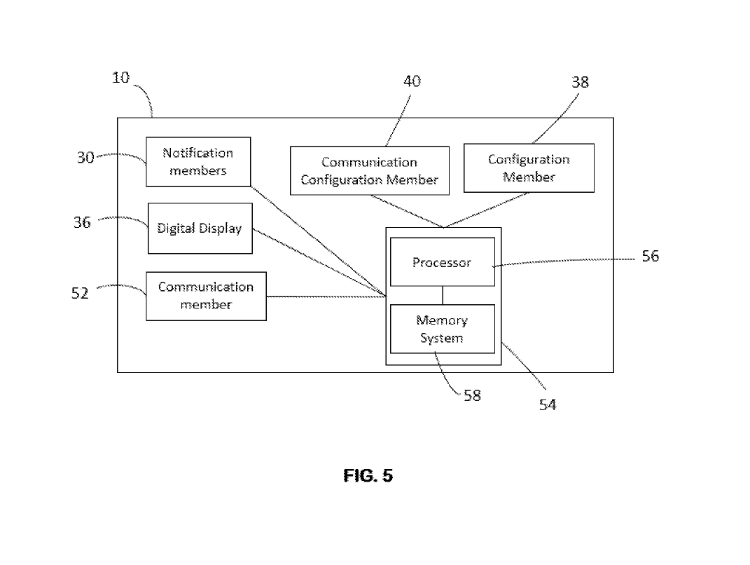

The front end 24 comprises of a digital display 36. The digital display 36 displays information regarding the expiration date of a tag. In the present embodiment, the digital display 36 is located on the upper portion of the front end 24. Further, the front end 24 includes a configuration member 38 for configuring the information displayed of the digital display 36. In a none-limiting example, the configuration member 38 configures the date displayed on the digital display 36 by resetting or adjusting the date. The date and time setting mechanism will be discussed in connection with FIG. 5. The configuration member 38 also controls the notification members 30, 30′, 30″. For example, when the notification members 30, 30′, 30″ are reset, the green light of the notification members 30, 30′, 30″ turns on for a predetermined period before the predetermined period expires. For example, the predetermined period is for number days that an inspection or registration tag is valid, one year, or one month.

In some embodiments, the front end 24 includes a communication configuration member 40. The communication configuration member 40 activates a communication member 52 (See FIG. 5) located within the housing 20. The communication member 52 may be a transceiver, Bluetooth, or Wi-Fi device. In the present embodiment, the configuration members 38 and communication configuration member 40 are electric switches selected from a group comprising switches, keys, or a combination thereof. The communication member allows the IREAS 10 to communicate with other devices, such as cellphones, computers, vehicle computer systems, electronic tablets, smartphones, computers, etc.

For example, as shown in FIG. 5, the digital display 36 displays that the tag expires on Oct. 31, 2013. The date shown on the digital display 36 corresponds with the expiration date of the tag itself. Here, the user can has selected the expiration date using the configuration member 38. For example, the user adjusts and defines a predefine period by setting the IREAS to generate expiration notification by toggling through days, months, and years in the digital display to record the expiration date and by saving those information in a memory system 58 of the control system 54. (See FIG. 5.) These predefine periods are described for purposes of example only and can be any combination of periods.

In some embodiments, the IREAS 10 offers a non-adjustable predefined period (e.g., one year) with preset notification periods (e.g., green light for first eleven months, yellow light for the twelfth month, and red light upon expiration). In this embodiment, the predefined period begins when the user presses the configuration member.

Furthermore, the user can preset a countdown periods wherein each preset count down period is less than the predefined period. The preset countdown period may contain specific dates upon which each notification members 30, 30′, 30″ get activated. For example, the user may preset a countdown period for eleven months as a compliance period and associate that with the green light. The user may preset a second period from the last twelfth month for reminding the user that the registration will expire by end of that month, the user would associate that period to the yellow light. The user may preset an expiration period which ending in 12 months, and the expiration will cause the red light to come on. These preset periods are described for purposes of example only and can be any combination of periods.

Furthermore, a speaker member 42, which emits a tone, can alert the user about the status of the tag. The tone generated by the speaker member 42 can be any sound generated through a speaker. In the present embodiment, the speaker member 42 works in conjunction with the notification members 30, 30′, 30″ to notify the user about the expiration of the tag.

Besides, the IREAS 10 can be selectively programmed to emit the audible and visual notifications at predetermined intervals including at least once a day, at least once a week, at least once a month, and at least once a year. These predetermined intervals are described for purposes of example only and can be any combination of intervals. The audible and visual notifications will be emitted at any of the above intervals until the user selective reprograms a new date, time and pattern using the configuration member 38. For example, the notification generated by the speaker can be emitted for a predetermined length of time and then automatically turned off. Alternatively, the notifications can be disabled by the configuration member 38 of the present invention.

Further, upon the activation of the communication member 52. A secondary device could control the IREAS 10. The secondary device may include a program such as an embedded software program or an installable software program on the secondary device for selectively programming the IREAS 10. For example, a secondary device such as a smart phone may have an application (e.g., app) that synchronizes with the IREAS 10 to selectively program IREAS 10, as well as receiving notification alerts from the IREAS 10.

FIG. 5 is a block diagram of the of the notification mechanism of the present Invention. The IREAS 10 includes a control system 54 positioned within the housing 20. The control system 54 includes a processor 56 and a memory system 58. The digital display 36 is connected to the control system 54, which using the processor 56 and the memory system 58 selectively controls what data is displayed in the digital display 36. The memory system 58 having a time mechanism (not shown) defined therein is connected to the processor 56 for keeping track of the predefined period, preset periods, and time left before a tag is expired. The predefined period is adjusted using the configuration member 38 connected to the control system 54. The communication configuration member 40 is connected to the control system 54. The control system 54 is connected to the communication member 52, and activates the communication member 52 when the user presses the communication configuration member 40. The second device using the communication member 52 communicates with the control system 54.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### SUMMARY OF THE INVENTION

A notification system for tag comprising a housing having a front end, a rear end, an opening between the front end and the rear end, a battery receiving member for receiving a battery, and a control system; the front end having notification members and an attachment member; the rear end having a digital display and a configuration member; wherein the control system, the digital display, the notification members and the configuration member 38 are in communication; wherein the attachment member coupling to the inside portion of a windshield of a vehicle; and wherein the opening placing upon a tag.

A notification system for a tag comprising a housing comprising of a front end, a rear end, an opening between the front end and the rear end, and a control system; the front end having an attachment member; the rear end having a configuration member, a communication configuration member, communication members, notification members, and a digital display, wherein the configuration member controlling the notification members and the communication configuration member controlling the communication member; wherein the control system, the configuration members, the communication configuration member, the communication member, the notification members, and the digital display are all in communication; wherein the attachment member coupling to the inside portion of a windshield of a vehicle; and wherein the opening placing upon a tag.

A system comprising a housing, wherein the housing comprising of a front end, a rear end, an opening between the front end and the rear end, a battery receiving member, notification members, a communication member, and a control system; the front end having an attachment member and a solar screen; the rear end having a configuration member, a communication configuration member, a digital display, wherein the first configuration member controlling the communication member, and the configuration member controlling the digital display and the notification members; wherein the attachment member coupling to the inside portion of a windshield of a vehicle; and wherein the opening placing upon a tag.

1- A notification system for a tag comprising:
a housing having a front end, a rear end, an opening between the front end and the rear end, a battery receiving member for receiving a battery, and a control system;
the front end having notification members and an attachment member;
the rear end having a digital display and a configuration member;
wherein the control system, the digital display, the notification members, and the configuration member are in communication;
wherein the attachment member coupling to the inside portion of a windshield of a vehicle; and wherein the opening placing upon a tag.

2- The notification system for a tag of claim 1, further comprising a speaker member for announcing notifications.

3- The notification system for a tag of claim 1, further comprising a communication member for communicating with a second device selected from a group consisting of smartphone, PDA, electronic tablet, and computer.

4- The notification system for a tag of claim 1, further comprising a solar screen for providing electricity to the housing.

5- The notification system for a tag of claim 1, wherein control system comprising a memory system and a processor.

6- The notification system for a tag of claim 1, wherein the communication member is selected from a group consisting of Wi-Fi, transceiver, and Bluetooth.

7- The notification system for a tag of claim 1, wherein the configuration member configuring the digital display and the notification members, and wherein both front and rear end have the notification members.

8- A notification system for a tag comprising:
a housing comprising of a front end, a rear end, an opening between the front end and the rear end, and a control system;
the front end having an attachment member;
the rear end having a configuration member, a communication configuration member, communication members, notification members, and a digital display, wherein the configuration member controlling the notification members and the communication configuration member controlling the communication member;
wherein the control system, the configuration members, the communication configuration member, the communication member, the notification members, and the digital display are all in communication;
wherein the attachment member coupling to the inside portion of a windshield of a vehicle; and wherein the opening placing upon a tag.

9- The notification system for a tag of claim 8, wherein the communication member communicating with a second device; wherein the second device providing input for the digital display and the notification members; and wherein the second device is selected from a group consisting of smartphone, PDA, electronic tablet, and computer.

10- The notification system for a tag of claim 8, further comprising a battery-receiving member for receiving at least one battery.

11- The notification system for a tag of claim 8, further comprising a speaker for announcing notifications.

12- The notification system for a tag of claim 8, further comprising a battery level identification feature.

13- The notification system for a tag of claim 8, wherein the control system activates at least one of the notification members, digital display, and speaker member corresponding to preset intervals of a predetermined period.

14- The notification system for a tag of claim 8, wherein the notification members comprising plurality of colored lights.

15- A system comprising:
a housing comprising of a front end, a rear end, an opening between the front end and the rear end, a battery receiving member, notification members, a communication member, and a control system;
the front end having an attachment member and a solar screen;
the rear end having a configuration member, a communication configuration member, a digital display, wherein the first configuration member controlling the communication member, and the configuration member controlling the digital display and the notification members;
wherein the attachment member coupling to the inside portion of a windshield of a vehicle; and wherein the opening placing upon a tag.

16- The system of claim 15, further comprising a speaker member for announcing notifications.

17- The system of claim 15, further comprising the communication member communicating with a second device.

18- The system of claim 17, wherein the second device is a device selected from a group consisting of smartphone, vehicle's computer system, computer, electronic watch, electronic tablet, and a combinations thereof.

19- The system of claim 15, wherein the notification members comprising a plurality of colored lights.

20- The system of claim 15, the second device controlling the control system.
